(19) United States
(12) Patent Application Publication
(10) Pub. No.: US 2016/0381597 A1
(43) Pub. Date: Dec. 29, 2016

(54) WiFi Airtime Allocation

(71) Applicant: Relay2, Inc., Milpitas, CA (US)

(72) Inventors: Pramod Babu Gummaraj, Bangalore (IN); Privinesh Kunhikannan, Vellikulangara Orkatteri Post (IN); Guharajan Sivakumar, Bangalore (IN); RaviKiran Mattaparti, Bangalore (IN)

(73) Assignee: RELAY2, INC., Milpitas, CA (US)

(21) Appl. No.: 14/749,580

(22) Filed: Jun. 24, 2015

(51) Int. Cl. H04W 28/06; H04W 28/02

(52) U.S. Cl. CPC H04W 28/06; H04W 28/0289

(57) ABSTRACT

A given connected wireless client device/node in a wireless communication system is controlled to consume its allocated airtime in a controlled distributed manner across a cycle to prevent excessive hogging of a transmission channel and/or to prevent excessive dropping of packets.

### TECHNICAL FIELD

The present invention is directed to wireless communications, and more specifically to aspects of WiFi network architecture and services.

### BRIEF DESCRIPTION OF THE DRAWINGS

FIG. 1 is a high-level network diagram showing aspects of distributing the consumption of airtime allocated to each connected wireless client device across a cycle time in a wireless communication network, according to certain embodiments.

FIGS. 2A, 2B, 2C, and 2D are high-level flow charts showing aspects of an airtime calculation engine for wireless nodes client devices connected to wireless access point devices in a wireless network, according to certain embodiments.

FIG. 3 is a high-level network flow chart showing aspects of an airtime distribution engine for wireless nodes client devices connected to wireless access point devices in a wireless network, according to certain embodiments.

FIG. 4 is a high-level network flow chart showing aspects of a throttler for wireless nodes client devices connected to wireless access point devices in a wireless network, according to certain embodiments.

FIG. 5 is a high-level network flow chart showing aspects of a feedback engine for wireless nodes client devices connected to wireless access point devices in a wireless network, according to certain embodiments.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, the consumption of airtime allocated to each connected wireless client device (also referred to herein as a connected wireless node) of at least a subset of wireless client devices/nodes that are connected to corresponding access point devices in a wireless system is distributed across a cycle time. According to certain embodiments, a cycle time is a predetermined value and is the duration of time per iteration.

According to certain embodiments, the consumption of airtime that is allocated to each wireless client device/node is distributed across a cycle period based on calculating the airtime required for the given wireless client device/node of a plurality of wireless client devices/nodes for transmitting a packet when connected to a corresponding access point device in the wireless communication system.

According to certain embodiments, the airtime allocated to each connected wireless client device/node is estimated based on comparing the required airtime for the respective connected wireless client device/node with the available airtime for each connected wireless client device/node, where available time is the total available airtime in the cycle divided by the total number of connected wireless nodes.

According to certain embodiments, the consumption of airtime that is allocated to each wireless client device is distributed across a cycle period based on comparing the consumed airtime of the given wireless client device/node with the elapsed cycle time when the given wireless client is connected to a corresponding access point device in the wireless communication system.

According to certain embodiments, the distribution of consumption of airtime allocated to each connected wireless client device/node across a cycle period in the wireless communication system of a plurality of wireless client devices/nodes includes throttling transmission of packets of the given connected wireless client device/node based on one or more pre-determined criteria.

According to certain embodiments, the distribution of consumption of airtime allocated to each connected wireless client device/node across a cycle period in the wireless communication system of a plurality of wireless client devices/nodes includes providing feedback information including computation of airtime transmission of a given packet by the given connected wireless client device/node through its associated access point device.

A given connected wireless client device/node in a wireless communication system can consume its corresponding allocated airtime per cycle all at once in the cycle. Such a connected wireless client device/node can result in hogging the transmission channel at its associated access point device. Thus, according to certain embodiments, a given connected wireless client device/node in a wireless communication system is controlled to consume its allocated airtime in a controlled distributed manner across a cycle to prevent excessive hogging of a transmission channel and/or to prevent excessive dropping of packets.

According to certain embodiments, such a wireless communication system periodically estimates the airtime required by a given connected wireless node and throttles the given node's transmission of packets across a given cycle based on the usage of airtime per cycle. Further, such a wireless communication system provides correction feedback information per cycle to the airtime estimation engine.

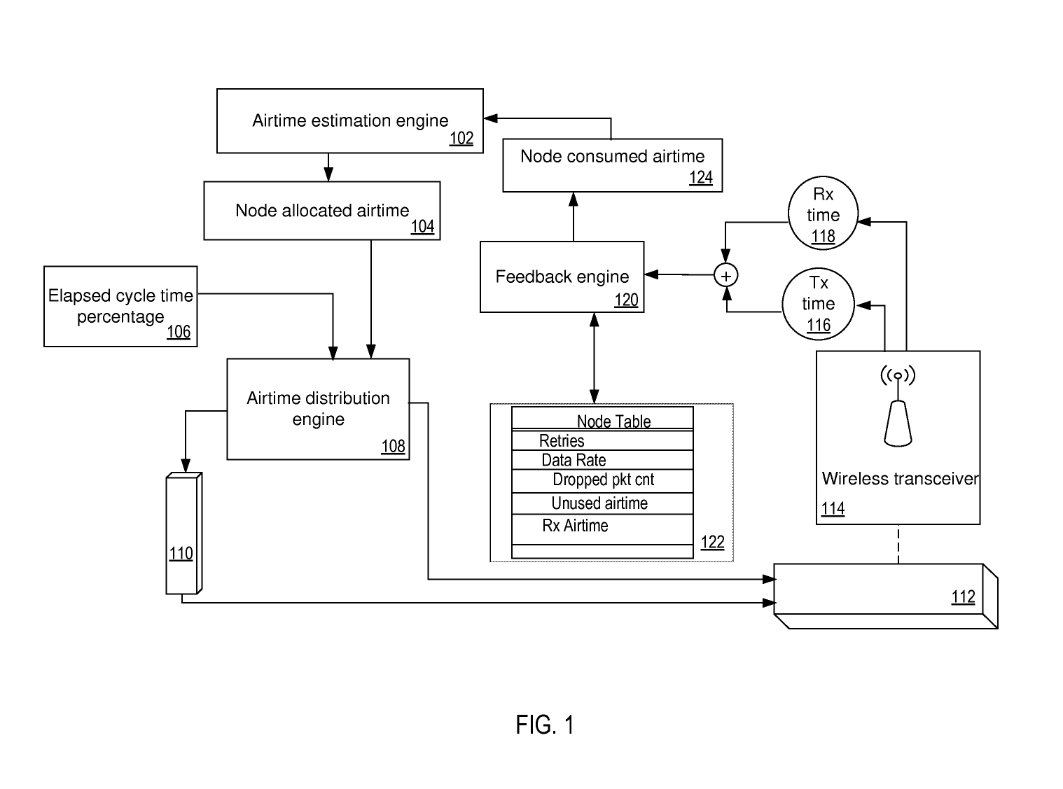

FIG. 1 is a high-level network diagram showing aspects of distributing the consumption of airtime allocated to each connected wireless client device across a cycle time in a wireless communication network, according to certain embodiments. In FIG. 1, at block 102, the airtime estimation engine calculates the node allocated airtime for a given connected wireless node of at least a subset of a plurality of wireless nodes connected to a corresponding access point in the wireless communication network to produce the corresponding node allocated airtime result at block 104. Node allocated airtime is the duration of time allocated to a connected wireless node for receiving and transmitting packets per cycle time, according to certain embodiments. At block 108, an airtime distribution engine receives an elapsed cycle time percentage value as an input from block 106 and also receives the node allocated airtime result from block 104 and uses such inputs for determining whether to send a packet that the given connected wireless node is attempting to send (or receive) to a throttler at block110 or to send the packet to the wireless transceiver at block 112. FIG. 1 also shows some functional aspect of the wireless transceiver at the physical layer shown at block 114. At the physical layer, the wireless transceiver adds the time that the given connected wireless node used to transmit (116) a given packet with the time the given connected wireless node used to receive (118) a packet and send the information to a feedback engine 120). The feedback engine 120 updates a feedback table 122. For example, the feedback table includes information such as number of transmission retries, data rate, unused airtime, drop airtime, transmission airtime, receiving airtime, Request-to-Send (RTS) flags, Clear-to-Send (CTS) flags etc, according to certain embodiments. At block 124, the feedback engine send information on the airtime consumed by the given connected wireless node to the airtime estimation engine. The process described with reference to FIG. 1 is repeated for each connected wireless node of at least a subset of a plurality of wireless nodes connected to the corresponding access point in the wireless communication network, according to certain embodiments.

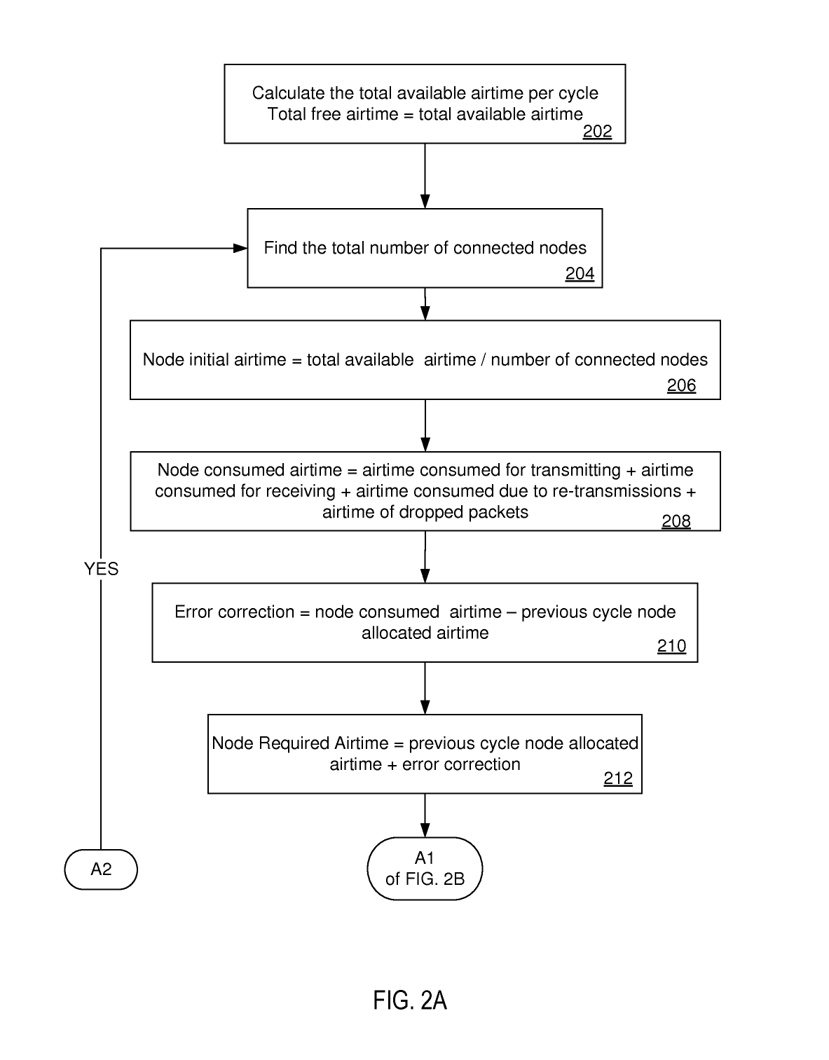

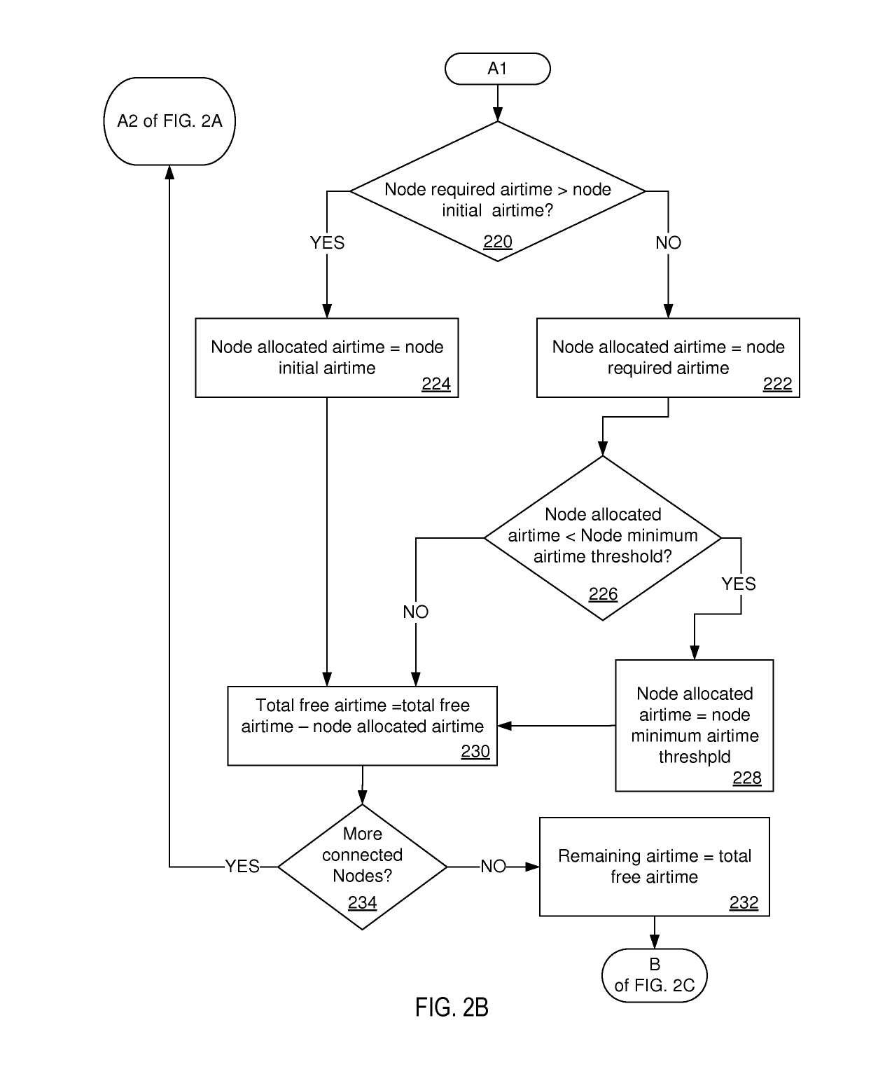

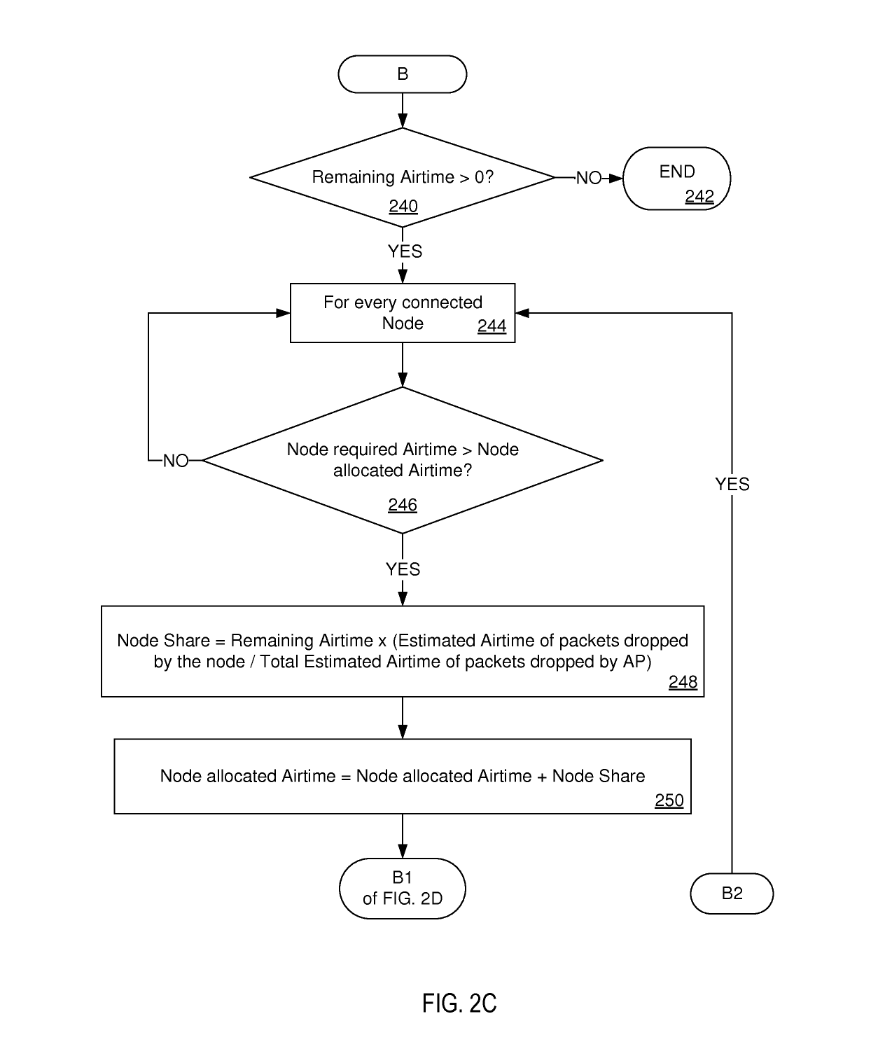

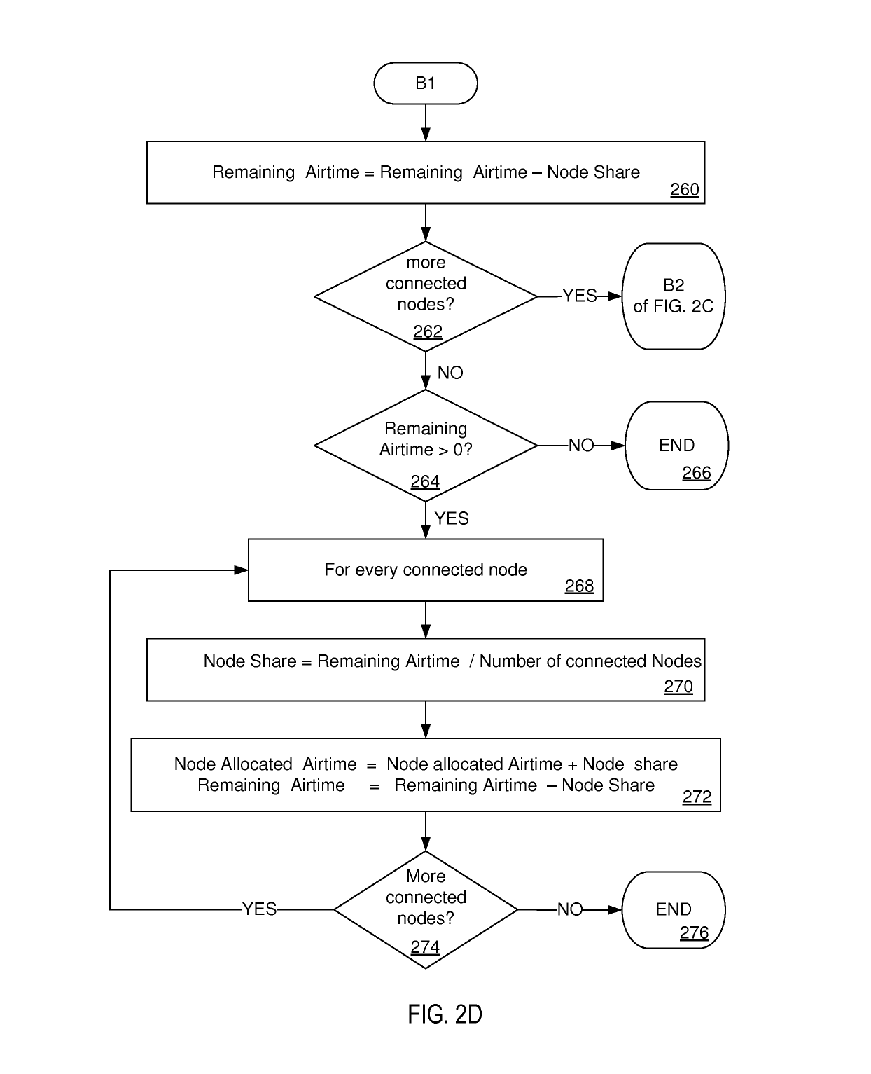

FIGS. 2A, 2B, 2C, and 2D are high-level flow charts showing aspects of an airtime calculation engine for wireless nodes client devices connected to wireless access point devices in a wireless network, according to certain embodiments. The processes in FIGS. 2A, 2B, 2C, and 2D are described with respect to a given connected wireless node and are repeated for each connected wireless node of at least a subset of the plurality of wireless nodes connected to the corresponding access point in the wireless communication network, according to certain embodiments.

At block 202 in FIG. 2A, the airtime estimation engine calculates the total available airtime per cycle for a given connected wireless node. According to certain embodiments, the total available airtime=(100−channel congestion)×cycle time, according to certain embodiments. For example, the channel congestion is the amount of channel capacity that is currently in use and therefore not available for transceiving packets for the given connected wireless node. Further, at block 202, total free airtime =total available airtime. At block 204, the airtime estimation engine determines the total number of wireless nodes connected to the given access point (referred herein as “connected wireless nodes”) in the wireless communication network. At block 206, the airtime estimation engine calculates the airtime than can be shared by the connected wireless nodes. Such an estimate is referred to as a node initial airtime. Node initial airtime=total available airtime/number of connected wireless nodes, according to certain embodiments. At block 208, for the given connected wireless node, the airtime estimation engine calculates the airtime used by the given connected wireless node (also referred to as “node used airtime” or “node consumed airtime”) in the previous cycle. The node consumed airtime is provided by the feedback engine as explained in greater detail herein. The node used airtime will be zero for wireless nodes that are newly connected to the access point in the current cycle. According to certain embodiments, at block 208, the airtime estimation engine makes the following calculation: node used airtime=airtime consumed by the given connected node for transmitting packets+airtime consumed by the given connected node for receiving packets+airtime consumed by the given connected node due to re-transmissions+estimated airtime consumed by the given connected node for packets dropped.

Re-transmissions are also known as retries. A Wifi medium is not a deterministic medium because of channel interference. There may be many retries in the channel due to interference. Retries are the number of times a connected wireless node tries to transmit a data packet until the packet is successfully transmitted. For example, a successful transmission is when the connected wireless node receives an acknowledgment for each of the data packets it has transmitted. A given connected wireless node will retry sending packets that are not acknowledged by the receiver. Retries are more frequent when the Wifi channel is congested, or if the given connected wireless node is far away from the access point and/or is not in the line of sight of the access point. In some wireless chipsets of wireless nodes, the number of retries may be pre-programmed for every packet so that the packets are resent automatically.

A connected wireless node that attempts many retries will occupy much more airtime than a connected wireless node that is able to send data packets successfully with few or no retires. RTS/CTS (Request to Send/Clear to Send) comprise an optional mechanism used by the 802.11 wireless networking protocol to reduce frame collisions introduced by wireless node problems. As the number of retries grows, the rate controller of the Wifi system will assume that the link quality is bad and will try to protect each frame with RTS/CTS messages. The amount of airtime consumed by RTS/CTS messages needs to be accounted for with respect to the given connected wireless node that is attempting to send the data packet. For purposes of illustration, assume that connected Wireless Node1 and Wireless Node2 are attempting to send packets. Further assume that Wireless Node1 is sending packets with RTS/CTS exchange mechanism. The airtime consumed by Wireless Node1 will be higher than that of Wireless Node2.

At block 210 of FIG. 2A, the airtime estimation engine calculates the error correction based on the inputs for the previous cycle. The error correction is needed to calculate the airtime required by the given connected wireless node for transmitting/receiving packets. According to certain embodiments, error correction=node used airtime−previous cycle node allocated airtime.

At block 212 of FIG. 2A, the airtime estimation engine calculates the airtime required by the given node in the current cycle to transmit/receive packets. According to certain embodiments, the node required airtime=previous cycle node allocated airtime+error correction. Control of the process passes to block A1 of FIG. 2B.

At block 220 of FIG. 2B, the airtime estimation engine determines, for the given connected wireless node, if the node required airtime is greater than the node initial airtime. If the node required airtime is greater than the node initial airtime, then at block 224, the given node is allocated the node initial airtime. At block 230, the total free airtime is calculated again as: total free airtime=total free airtime−node allocated airtime. At block 234, the airtime estimation engine determines if there are more connected wireless nodes for which airtime needs to be estimated. If there are more connected wireless nodes for which airtime needs to be estimated, then control passes to block A2 of FIG. 2A. From block A2 of FIG. 2A, control passes back block 204 that is previously described herein with reference to FIG. 2A. If there are no more connected wireless nodes for which airtime needs to be estimated, then control passes to block B of FIG. 2C as described herein.

If at block 220, it is determined that the node required airtime is not greater than the node initial airtime, then at block 222, the node allocated airtime is set as equal to the node required airtime, according to certain embodiments. Next, at block 226, it is determined if the node allocated airtime is less than the node minimum airtime threshold. The node minimum airtime threshold is a predetermined value, according to certain embodiments. If it is determined that the node allocated airtime is not less than the node minimum airtime threshold, then control passes to block 230. Block 230 is previously described above. If it is determined that the node allocated airtime is less than the node minimum airtime threshold, then at block 228, the node allocated airtime is set as equal to node minimum airtime threshold, in order to avoid a zero value, according to certain embodiments.

As shown in FIG. 2C, control passes from block B to block 240 where it is determined if the remaining airtime is greater than zero. If it is determined that the remaining airtime is not greater than zero then the process ends block 242. If it is determined that the remaining airtime is greater than zero, then each wireless node connected to the access point is considered at block 244. At block 246, for the connected wireless node under consideration at block 244, it is determined if the node required airtime is greater than the node allocated airtime. If at block 246, if it is determined that the node required airtime is greater than the node allocated airtime, then at block 248, the node share for the given node is calculated as: node share=remaining airtime×(estimated airtime of packets dropped by the given node/total estimated airtime of packets dropped by the given access point). At block 250, the airtime estimation engine calculates the node allocated airtime as: node allocated airtime=node allocated airtime+node share, according to certain embodiments. According to certain embodiments, the purpose of a “node share” is to share the unused airtime among connected wireless nodes that need more airtime. Next, control passes to block B1 of FIG. 2D. If at block 246, it is determined that the node required airtime is not greater than the node allocated airtime, then control passes back to block 244 where the airtime estimation moves to the next connected wireless node for consideration as described with reference to block 246.

As shown at block B1 of FIG. 2D, control passed to block 260 where the airtime estimation engine calculates the remaining airtime for the given connected wireless node is calculated as: remaining airtime=remaining airtime−node share. At block 262, it is determined if there are more connected wireless nodes to be considered. If there are more connected wireless nodes to be considered, then control passes back to block B2 of FIG. 2C. As shown in FIG. 2C, from block B2, control passes to block 244 that is previously described herein with reference to FIG. 2C.

If at block 262, it is determined that there are no more connected wireless nodes to be considered, then at block 264, it is determined if the remaining airtime is greater than zero. If it is determined that the remaining airtime is not greater than zero, then the process ends at block 266. If however it is determined at block 264 that the remaining airtime is greater than zero, then at block 268 each connected wireless node is considered for calculating its node share at block 270 as: node share=remaining airtime/number of wireless nodes connected to the access point. At block 272, the airtime estimation engine sets the node allocated airtime for the given connected wireless node under consideration as: node allocated airtime=node allocated airtime+node share. Further at block 272, the airtime estimation engine sets the remaining airtime as: remaining airtime=remaining airtime−node share. At block 272, it is determined if there are more connected wireless nodes to be considered. If there are no more connected wireless nodes to be considered, then the process ends at block 276. If however, there are more connected wireless nodes to be considered, then control passes back to block 268.

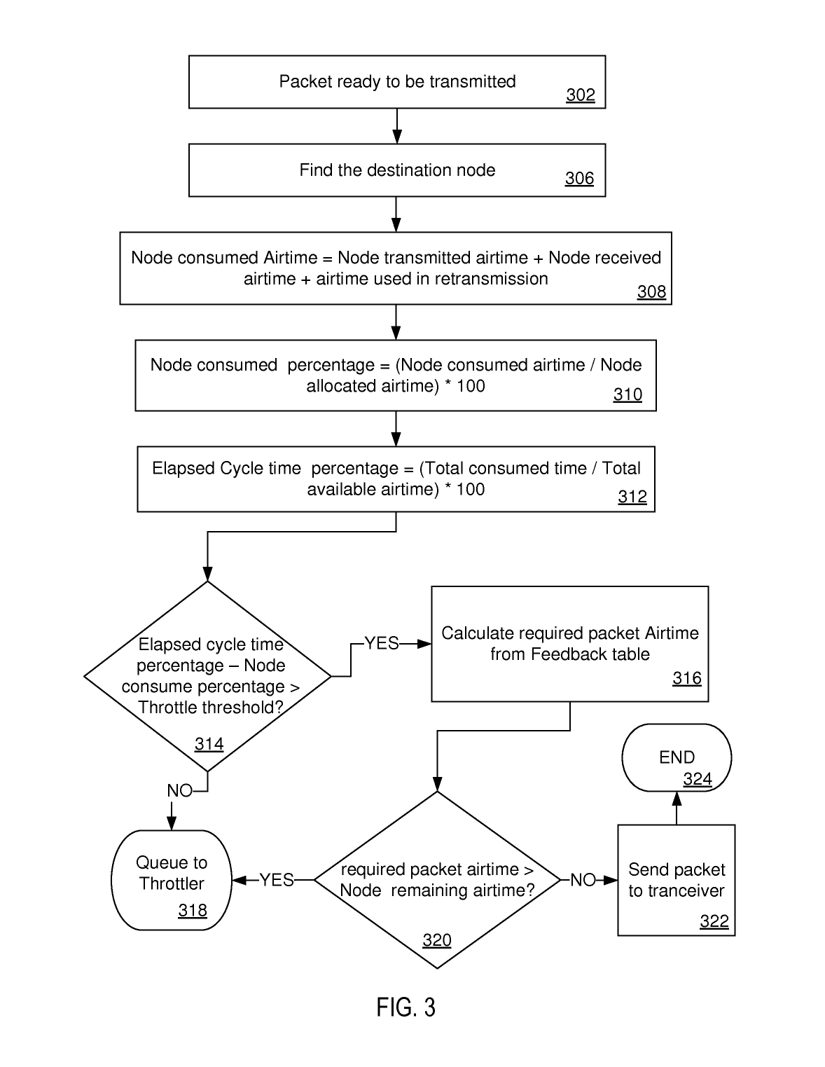

FIG. 3 is a high-level network flow chart showing aspects of an airtime distribution engine for wireless nodes client devices connected to wireless access point devices in a wireless network, according to certain embodiments. When a data packet associated with a given connected wireless node is ready to be transmitted at block 302, the airtime distribution engine finds the destination wireless node at block 306. At block 308, the airtime distribution engine calculates the consumed airtime for the given destination wireless node found at block 306 as: destination node consumed airtime=airtime consumed by the destination node for transmitting packets+airtime consumed by the destination node for receiving packets+airtime consumed by the destination node due to re-transmissions. The airtime consumed by the destination node for transmitting packets, the airtime consumed by the destination node for receiving packets, and the airtime consumed by the destination node due to re-transmissions information can be obtained from the feedback table. At block 310, the airtime distribution engine calculates the destination node consumed airtime percentage as: destination node consumed airtime percentage=(destination node consumed airtime/destination node allocated airtime)×100. At block 312, the airtime distribution engine calculates the elapsed cycle time percentage as: elapsed cycle time percentage=(total airtime consumed by all the connected wireless nodes in the cycle/total available airtime)×100. At block 314, the airtime distribution engine determines if the elapsed cycle time percentage minus the destination node consumed airtime percentage is greater than the throttle threshold value. The throttle threshold value is a predetermined value according to certain embodiments. If it is determined that the elapsed cycle time percentage minus the destination node consumed airtime percentage is not greater than the throttle threshold value, then at block 318, the given data packet is queued to the throttler. However, if it is determined that the elapsed cycle time percentage minus the destination node consumed airtime percentage is greater than the throttle threshold value, then at block 316, the airtime distribution engine calculates the required airtime for transmitting the given data packet (“required packet airtime”) based on information for the feedback table. According to certain embodiments, the required packet airtime is a function of packet length, selected data rate, previous retries for the selected data packet rate obtained from the feedback table. At block 320, the airtime distribution engine determines if the required airtime for transmitting the given data packet is greater than the destination node's remaining airtime. If it is determined that the required airtime for transmitting the given data packet is greater than the destination node's remaining airtime, then control passes to block 318 where the given data packet is queued to the throttler. However, if it is determined that the required airtime for transmitting the given data packet is not greater than the destination node's remaining airtime, then the data packet is sent to the wireless transceiver for transmission. The airtime distribution process ends at block 324.

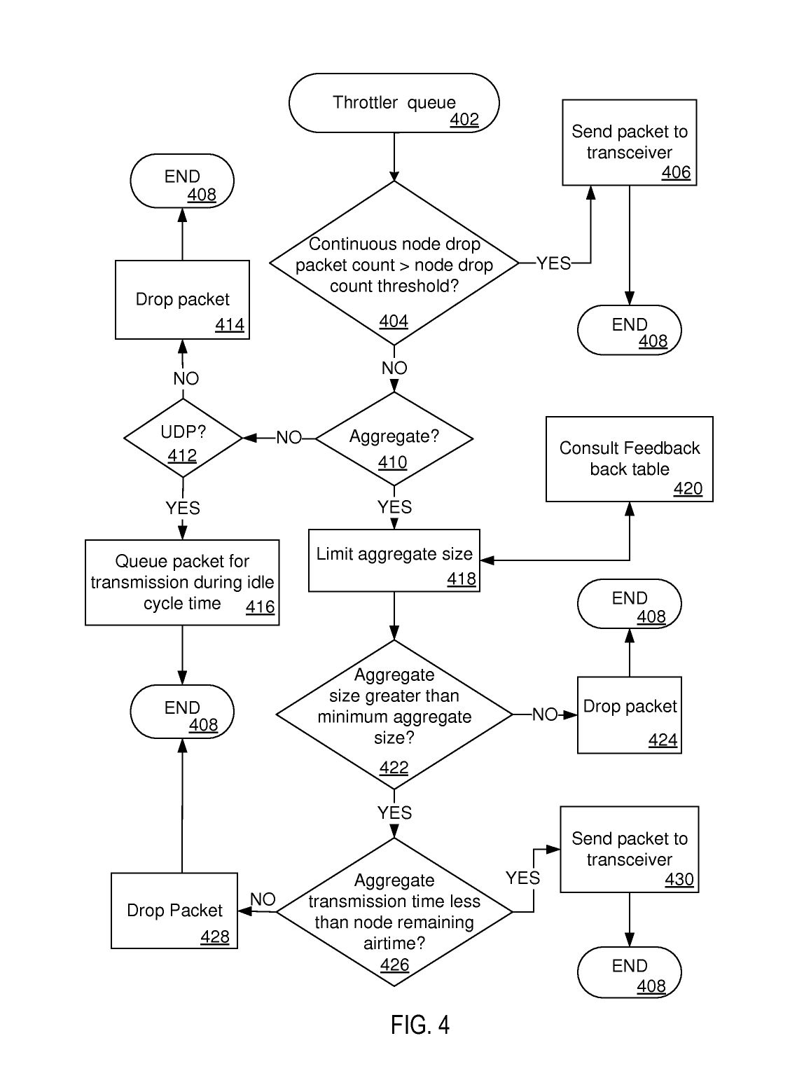

FIG. 4 is a high-level network flow chart showing aspects of a throttler for wireless nodes client devices connected to wireless access point devices in a wireless network, according to certain embodiments. In FIG. 4, block 402 operates on the next packet (current packet) in the throttler queue. At block 404, the throttler determines if the continuous dropped packet count of a given node associated with the current packet is greater than the dropped packet count threshold. According to certain embodiments, the dropped packet count threshold is a predetermined value. If it is determined that the continuous dropped packet count of the given node associated with the current packet is greater than the dropped packet count threshold, then the packet is sent to the wireless transceiver at block 406. However, if it is determined that the continuous dropped packet count of a given node associated with the current packet is not greater than the dropped packet count threshold, then at block 410, it is determined if the given current packet is an aggregate packet. If it is determined that the given current packet is an aggregate packet, then at block 418, the size of the aggregate packet is limited by consulting the feedback table at block 420. At block 422, it is determined if the size of the aggregate packet is greater than the minimum required aggregate size. If it is determined that the size of the aggregate packet is not greater than the minimum required aggregate size, then at block 424, the packet is dropped.

However, if it is determined that the size of the aggregate packet is greater than the minimum required aggregate size, then at block 426, it is determined if the transmission time for the aggregate packet is less than the remaining airtime of the destination node. If it is determined that the transmission time for the aggregate packet is less than the remaining airtime of the destination node then at block 430, the aggregate packet is sent to the wireless transceiver. However, if it is determined at block 426 that the transmission time for the aggregate packet is not less than the remaining airtime of the destination node, then at block 428, the aggregate packet is dropped.

If at block 410, it is determined that the current packet is not an aggregate packet, then at block 412, it is determined if the packet is a UDP packet. If it is determined that the packet is a UDP packet, then at block 416, the UDP packet is queued for transmission during the idle cycle time if there is an un-utilized airtime available at the end of cycle. According to certain embodiments, a decision may be made to drop the UDP packet if the number of packets queued thus far for the given connected wireless node exceeds a predetermined maximum value. When queuing each of the packets, the throttler will track the time required to transmit each of the packets based on the size of the packet, according to certain embodiments. As the time elapses in the current cycle, if the connected wireless nodes become idle (for example, there are no packets to be transmitted for any of the connected wireless nodes), then the throttler will transmit the queued UDP packets until one of the connected wireless nodes makes a transmission request. At the end of the cycle period, the packets remaining in the UDP queue will be dropped, according to certain embodiments.

However, if a block 412, it is determined that the packet is not a UDP packet (e.g., it is a TCP packet), then at block 414, the packet is dropped. The process ends at block 408.

At the end of each cycle time, the feedback engine provides feedback to the airtime estimation engine. The feedback information can include the number of packet dropped, the time take for transmission, the time wasted in retries and the time consumed for receiving the packets. According to certain embodiments, the feedback engine can be queried by the airtime distribution engine for the required airtime to transmit a packet.

According to certain embodiments, the airtime of a packet is computed at the completion of transmission of each packet. At the completion of transmission, the following information can be obtained from the access point hardware for computing airtime:
1. Size of the packet
2. Data Rate1, Number of tries1, RTS/CTS Flags
3. Data Rate2, Number of tries2, RTS/CTS Flags
4. Data Rate3, Number of tries3, RTS/CTS Flags
5. Data Rate4, Number of tries4, RTS/CTS Flags

According to certain embodiments, the access point hardware decides the rate of transmission for packets associated with each wireless node. According to certain embodiments, the feedback engine builds a lookup table referred to as a feedback table. As a non-limiting example, the feedback table includes supported PHY layer statistics such as:

RATE₁, RATE₂, . . . , RATE_{N}
RATE₁ TX PKTS , RATE₂ TX PKTS, . . .
RATE_{N} TXPKTS.
RATE ₁TX RETRIES, . . . , RATE_{N} TX
RETRIES
Unused Airtime
Transmission Airtime
Receiving Airtime
Drop Airtime
TX = transmission, PKTS = packets.

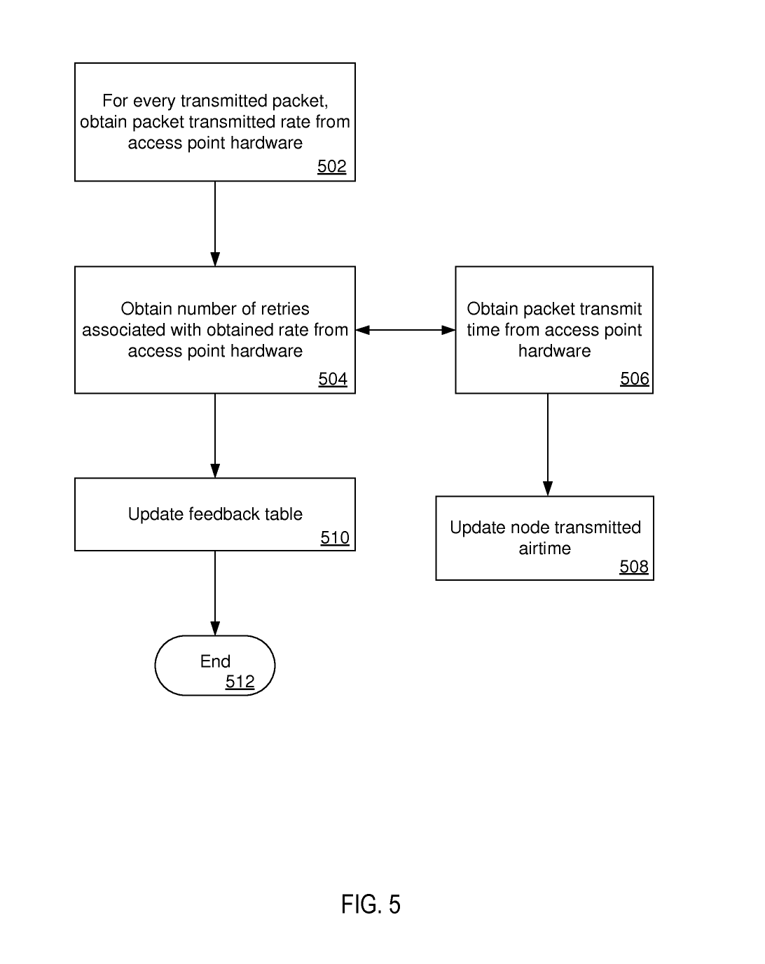

FIG. 5 is a high-level network flow chart showing aspects of a feedback engine for wireless client devices/nodes connected to wireless access point devices in a wireless network, according to certain embodiments. At block 502 in FIG. 5, for each transmitted packet, the feedback engine obtains the rate of transmission information of the transmitted packet from the access point hardware. At block 504, the feedback engine obtains the number of retries associated with the transmission rate information obtained at block 502. At block 506, the feedback engine obtains the packet transmit airtime from the access point hardware. At block 508, the node transmitted airtime is updated by the feedback engine. At block 510, the feedback table is updated by the feedback engine. The process ends at block 512.

According to certain embodiments, a wireless communication system comprises an airtime estimation engine for determining a respective node allocated airtime in a cycle time period for a given wireless node connected to an access point in the wireless communication system and is based on comparing a required airtime for the given wireless node with an available airtime for the given wireless node in the wireless communication system. According to certain embodiments, the available time is a total available airtime in a cycle divided by a total number of connected wireless nodes in the wireless communication system. According to certain embodiments, such a system further comprises an airtime distribution engine for controlling the given wireless node's consumption of its node allocated airtime across the cycle time period and is based on comparing a consumed airtime percentage of the given wireless node with an elapsed cycle time percentage of the cycle time period.

According to certain embodiments, the wireless communication system further comprises a throttler engine for determining a packet type of each respective packet in a queue of the throttler engine. According to certain embodiments, the throttler engine queues the respective packet for transmission during idle cycle time if the packet type is determined to be a UDP type.

According to certain embodiments, the throttler engine limits packet size if the packet type of the respective packet is determined to be an aggregate type. According to certain embodiments, the throttler engine drops the respective packet if the packet type is determined to be a TCP type.

According to certain embodiments, the airtime distribution engine calculates a required packet airtime for a respective packet based on information from a feedback table. According to certain embodiments, the feedback engine obtains a respective packet transmission time.

According to certain embodiments, the wireless communication system further comprises a feedback engine for obtaining a respective packet transmission rate. According to certain embodiments, the feedback engine obtains a respective packet transmission time. According to certain embodiments, the feedback engine updates a feedback table.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A wireless communication system comprising:
an airtime estimation engine for determining a respective node allocated airtime in a cycle time period for a given wireless node connected to an access point in the wireless communication system based on comparing a required airtime for the given wireless node with an available airtime for the given wireless node in the wireless communication system, wherein the available time is a total available airtime in a cycle divided by a total number of connected wireless nodes in the wireless communication system; and
an airtime distribution engine for controlling the given wireless node's consumption of its node allocated airtime across the cycle time period based on comparing a consumed airtime percentage of the given wireless node with an elapsed cycle time percentage of the cycle time period.

2. The wireless communication system of claim 1, further comprising a throttler engine for determining a packet type of each respective packet in a queue of the throttler engine.

3. The wireless communication system of claim 2, wherein the throttler engine limits packet size if the packet type of the respective packet is determined to be an aggregate type.

4. The wireless communication system of claim 2, wherein the throttler engine drops the respective packet if the packet type is determined to be a TCP type.

5. The wireless communication system of claim 2, wherein the throttler engine queues the respective packet for transmission during idle cycle time if the packet type is determined to be a UDP type.

6. The wireless communication system of claim 1, wherein the airtime distribution engine calculates required packet airtime for a respective packet based on information from a feedback table.

7. The wireless communication system of claim 1, further comprising a feedback engine for obtaining a respective packet transmission rate.

8. The wireless communication system of claim 7, wherein the feedback engine obtains a respective packet transmission time.

9. The wireless communication system of claim 7, wherein the feedback engine updates a feedback table.
